(19) United States
(12) Patent Application Publication
(10) Pub. No.: US 2023/0144486 A1
(43) Pub. Date: May 11, 2023

(54) Cryptocurrency Transaction Process

(71) Applicant: Vincent Bono, SALEM, MA (US)

(72) Inventor: Vincent Bono, SALEM, MA (US)

(21) Appl. No.: 17/522,716

(22) Filed: Nov. 9, 2021

(51) Int. Cl. G06Q 20/06; G06Q 20/20; G06Q 20/36

(52) U.S. Cl. CPC G06Q 20/065; G06Q 20/204; G06Q 20/3674

(57) ABSTRACT

An improved cryptocurrency transaction process is disclosed herein. The cryptocurrency transaction process involves the use of a payment card to verify a cryptocurrency transaction. The payment card interacts with a point of sale terminal having a processor. The processor communicates with a database that carries out most of the remaining steps of the process. The cryptocurrency transaction process disclosed herein is a significant improvement over known methods and solves a number of problems in multiple arts described further herein.

### BACKGROUND

### Technical Field

The present disclosure relates generally to transaction processes that utilize one or more cryptocurrencies to pay for goods or services. More particularly, the present disclosure relates to an improved cryptocurrency transaction process, method, or system, that utilizes a payment card while remaining outside the purview of rules and regulations set by governments or standard setting organizations.

### Description of Related Art

Using currency as a method of purchasing goods or services has been known since ancient times. Traditionally, currency has been backed by governments, and this type of currency is generally referred to as fiat currency. In the increasingly digital age, other types of currency have come into prominence. Cryptocurrencies, such as Bitcoin, Ethereum, Litecoin, etc., that utilize blockchain and other similar technologies are known in the art.

Known methods of using cryptocurrency to pay for goods or services suffer from numerous shortcomings. One such shortcoming is that known methods are slow and require updates to the blockchain or other similar public transaction log in order to complete the transaction. Depending on the cryptocurrency, the process of updating the blockchain can take anywhere from 1 minute to 45 minutes.

Other methods of initiating a transaction and then selling cryptocurrency to generate fiat currency, which is in turn used to pay for goods and services, have developed as a workaround to the need to update the blockchain before the completion or settlement of a transaction. However, these methods also suffer from numerous shortcomings. One such shortcoming is that the selling of cryptocurrency to generate fiat currency is slow and can take anywhere from 45 seconds to 1 minute and 30 seconds. Another shortcoming is that the process of selling cryptocurrency to generate fiat currency subjects the intermediary selling the cryptocurrency to a host of rules and regulations.

There are a countless number of solutions to the aforementioned problems for which the results of applying the solutions are not predictable. Therefore, what is needed is an improved cryptocurrency transaction process having the following characteristics and benefits over the prior art.

### SUMMARY

The subject matter of this application may involve, in some cases, interrelated products, alternative solutions to a particular problem, and/or a plurality of different uses of a single system or article.

In one aspect of the present disclosure, a cryptocurrency transaction system comprising a payment card, a point of sale terminal, a transaction price, and a database is disclosed. In this aspect, the point of sale terminal comprises a processor, wherein the processor is operable to send an inbound authorization request to the database when the payment card interacts with the point of sale terminal. The database is operable to receive the inbound authorization request from the processor; verify an amount of cryptocurrency stored within a cardholder wallet; and transmit an accept or decline outbound authorization response from the database to the processor of the point of sale terminal. The database transmits the accept outbound authorization response to the processor of the point of sale terminal when the amount of cryptocurrency stored within the cardholder wallet is at least equal to the transaction price. The database transmits the decline outbound authorization response to the processor of the point of sale terminal when the amount of cryptocurrency stored within the cardholder wallet is less than the transaction price. In this aspect, the database is further operable to initiate a settlement process for the cryptocurrency transaction when the outbound authorization response is the accept outbound authorization response. The settlement process for the cryptocurrency transaction comprises the step of transferring the amount of cryptocurrency equal to the transaction price stored within the cardholder wallet to a merchant wallet.

In another aspect of the present disclosure, a method of using cryptocurrency to facilitate a transaction is disclosed. In this aspect, the method comprises the steps of: acquiring an amount of cryptocurrency, wherein the amount of cryptocurrency is stored in a cardholder wallet; providing a transaction price, a point of sale terminal, and a database; providing a payment card to the point of sale terminal. A processor carries out the step of sending an inbound authorization request to the database. The database carries out the steps of: receiving an inbound authorization request; verifying the amount of cryptocurrency stored in the cardholder wallet; transmitting an outbound authorization response from the database to the processor of the point of sale terminal; and initiating a settlement process for the transaction. The settlement process comprises the step of transferring the amount of cryptocurrency equal to the transaction price stored in the cardholder wallet to a merchant wallet.

### BRIEF DESCRIPTION OF THE DRAWINGS

FIG. 1 provides a schematic view of an embodiment of the present disclosure.

FIG. 2 provides another schematic view of an embodiment of the present disclosure.

FIG. 3 provides yet another schematic view of several embodiments of the present disclosure.

FIG. 4 provides a flow chart of an embodiment of the steps of the present disclosure.

FIG. 5 provides a flow chart of another embodiment of the steps of the present disclosure.

### DETAILED DESCRIPTION

The detailed description set forth below in connection with the appended drawings is intended as a description of presently preferred embodiments of the invention and does not represent the only forms in which the present disclosure may be constructed and/or utilized. The description sets forth the functions and the sequence of steps for constructing and operating the invention in connection with the illustrated embodiments.

Generally, the present disclosure concerns an improved cryptocurrency transaction process that allows the verification of natively crypto-to-crypto transactions in 15 seconds or less. The improved process benefits customers and merchants alike by allowing both parties to leverage the value of their digital currency to transact for goods and/or services in the marketplace. The improved process also benefits financial intermediaries offering cryptocurrency transaction services by allowing said intermediaries to avoid rules and regulation by (1) not selling cryptocurrency to generate fiat currency and (2) not using standard card transaction networks.

Cryptocurrencies, such as Bitcoin, Ethereum, Litecoin, etc. are known in the art as digital coins or currency and are commonly regarded as assets that may appreciate dramatically in value. In accordance embodiments of the present disclosure, digital currencies are also capable of being exchanged in the marketplace for goods and/or services of value, similar to fiat currency.

Cryptocurrencies may function as devices for the exchange of goods and/or services (i.e., currency) through the use of a peer-to-peer network (the “P2P network”) formed from a plurality of computers and/or servers that may be accessible through the Internet. When cryptocurrencies are exchanged or transferred from one cryptocurrency holder to another, what actually occurs is an update to a public transaction log or public ledger, which is commonly referred to as the “blockchain,” over the P2P network. In other words, the blockchain is a shared public ledger on which cryptocurrencies rely and all confirmed transactions are included in the blockchain.

Cryptocurrencies are stored in “digital wallets,” and a cryptocurrency transaction involves the transfer of cryptocurrency from one digital wallet to another over the blockchain. A crypto “digital wallet” is the pairing of a private key, used to sign transactions and provide proof that the signed transactions come from the owner of the wallet, and a public key, which is an address on the P2P network where the cryptocurrency is stored. Accordingly, as used throughout this disclosure, the term “customer” shall mean any cryptocurrency holder having a digital wallet and looking to purchase goods and/or services. Furthermore, the term “merchant” shall mean any person having a digital wallet and looking to sell said goods and/or services.

The present disclosure solves a number of problems in multiple arts. One problem is that cryptocurrencies may be an unreliable device for the purchase of goods and/or services. The reason for this is that cryptocurrencies may have the tendency to fluctuate dramatically in value, which causes them to be less reliable devices for the purchase of goods and/or services than fiat currency, which may not fluctuate so dramatically in value. The present disclosure solves this problem by providing a database, in communication with at least one digital wallet, that is capable of converting the value of fiat currency provided to the database to an amount of cryptocurrency in the digital wallet and obligating said amount of cryptocurrency equal to the value of the fiat currency based on the real-time value of the cryptocurrency. For example, if the value of the fiat currency provided to the database is $100, and the real-time value of one coin of the particular cryptocurrency is $2,000, then the amount of cryptocurrency converted and obligated by the database would be 0.05 digital coins.

The conversion and obligation of the cryptocurrency by the database may be done without selling the cryptocurrency to generate fiat currency. This aspect of the present disclosure may prevent the financial intermediary that provides the database from being characterized as a financial institution, which would subject said financial intermediary to governmental regulation. In other words, this aspect of the present disclosure solves the problem of financial intermediaries providing cryptocurrency transaction services generally being subjected to certain governmental regulations for financial institutions.

The present disclosure also solves the problem of slow transaction speeds for cryptocurrency transactions. The present disclosure solves this problem by providing a process that utilizes a payment card for verification of a cryptocurrency transaction and a database in communication with customer and merchant digital wallets that initiates settlement of the cryptocurrency transaction.

Payment card transactions follow two general steps: (1) verification; and (2) settlement. The verification step encompasses the authorization stage and the authentication stage. During the authorization stage, a merchant receiving a payment card obtains approval for payment from the issuer, and, during the authentication stage, the issuer verifies the validity of the payment card. The settlement step may also be referred to as the clearing and settlement stage, wherein the transaction is posted to the cardholder's billing statement and the merchant's statement, simultaneously. As will be appreciated by those skilled in the art, the verification and settlement steps for payment cards usually occur over standard card transaction networks due to payment card issuers having addresses accessible over those said networks. For example, payment card companies such as Visa® and MasterCard® have relationships with merchants an issuing banks, and, accordingly, have standard card transaction networks for the verification and settlement of transactions utilizing their payment cards. These standard card transaction networks are subject to governmental regulation as well as regulation by standard setting organizations.

Accordingly, the present disclosure also solves the problem of financial intermediaries processing payment card transaction generally being subjected to regulations by governmental and standard setting authorities by providing a database for processing cryptocurrency transaction that is accessible over a network that is not a standard card transaction network.

In most embodiments, the first step of the disclosed process is for a customer to acquire cryptocurrency, wherein the cryptocurrency is stored in an original digital wallet. In some embodiments, the customer may acquire cryptocurrency in exchange for fiat currency through a brokerage or other similar types of financial intermediaries that allow customers to buy and sell cryptocurrencies. Regardless of how a customer acquires cryptocurrencies stored in the original digital wallet, another step of the process may be for the customer to acquire an account with a financial intermediary that provides payment cards comprising encrypted addresses, wherein said encrypted addresses are associated with a database for cryptocurrency transactions. In these embodiments, the addresses encrypted on the payment cards may be addresses associated with cardholder digital wallets, wherein a customer may transfer cryptocurrency stored in an original digital wallet to a cardholder digital wallet.

In most embodiments, a merchant will also acquire an account with a financial intermediary that provides access to the database for cryptocurrency transactions and an associated merchant digital wallet for the storage and receipt of said cryptocurrency. In some embodiments, merchants and customers acquiring accounts with the same financial intermediary may facilitate the speed of the cryptocurrency transaction. In a preferred embodiment, the financial intermediary associated with the cardholder digital wallet and merchant digital wallet will not allow customers or merchants to buy or sell cryptocurrency in exchange for fiat currency. This preferred embodiment avoids the aforementioned problem of a financial intermediary being subjected to governmental regulation as a financial institution.

In most embodiments, the merchant may also acquire a point of sale (“POS”) terminal, wherein the POS terminal may comprise a processor capable of communicating with the cryptocurrency transaction database. In most embodiments, after beginning the purchase of goods and/or services, the customer may proceed with a cryptocurrency transaction by presenting a payment card to the POS terminal. In a preferred embodiment, the step of presenting or interacting the payment card with the POS terminal may comprise the step of inserting or dipping the payment card into the POS terminal. However, the step of presenting the payment card to the POS terminal may, for example, comprise the alternative or simultaneous steps of: swiping the payment card through the POS terminal; holding the payment card near the POS terminal; tapping the payment card on the POS terminal; or any other similar methods of presenting or interacting the payment card with the POS terminal.

In most embodiments, the processor within the POS terminal may be operable to receive an input for a transaction price in fiat currency and send that transaction price in fiat currency to the database. The database may then be operable to convert and obligate the corresponding amount of cryptocurrency equal to the transaction price from the customer's cardholder wallet. In some embodiments, the POS terminal may be operable to display a transaction price in fiat currency and/or cryptocurrency to the customer and the merchant. Accordingly, in most embodiments, the processor may be in communication with a database, and the database may be stored and/or located on a server. In some embodiments, the database may receive information from the processor through a listener, and the database may send information to the processor through a responder. In most embodiments, the listener and responder may be ports within the database.

In some embodiments, the database may comprise a plurality of database files that represent the amount of cryptocurrency within a plurality of digital wallets. The digital wallets may be a plurality of customer digital wallets and a plurality of merchant digital wallets. In some embodiments, the amount of cryptocurrency within any given digital wallet may be represented by cryptocurrency points, and the amount of cryptocurrency points may be represented in the database files associated with the particular digital wallet. In some embodiments, the database may also comprise a balance ledger. In some embodiments, the balance ledger may reveal the amount of cryptocurrency within at least one customer's digital wallet. In alternative or simultaneous embodiments, the balance ledger may reveal the amount of cryptocurrency points in at least one customer's database files.

In most embodiments, a database engine may allow the access to and manipulation of data within the database. In the present disclosure, the database engine may be referred to as the authorization engine. In some embodiments, the authorization engine may accomplish the transfer of cryptocurrency points from a customer's database files to a merchant's database files, wherein the points transferred may represent the transaction price. In some embodiments, the points may be transferred by the authorization engine during the verification step of the transaction in 15 seconds or less. These embodiments of the present disclosure provide another solution to the problem of slow cryptocurrency transaction speeds by transferring points representing cryptocurrency within a database before the transfer of the cryptocurrency from a customer's wallet to a merchant's wallet occurs later on the blockchain network during the settlement step of the transaction.

In preferred embodiments and during the process of settlement, a transfer of cryptocurrency from the customer's digital wallet to the merchant's digital wallet is initiated on a network. In preferred embodiments, the blockchain public transaction log is accessible over the network. In some embodiments, cryptocurrency is transferred from the customer's digital wallet to the merchant's digital wallet by changing the public key or address associated with an amount of cryptocurrency in the customer's wallet to the public key or address associated with the merchant's wallet. In preferred embodiments, the amount of cryptocurrency transferred is equal to the transaction price.

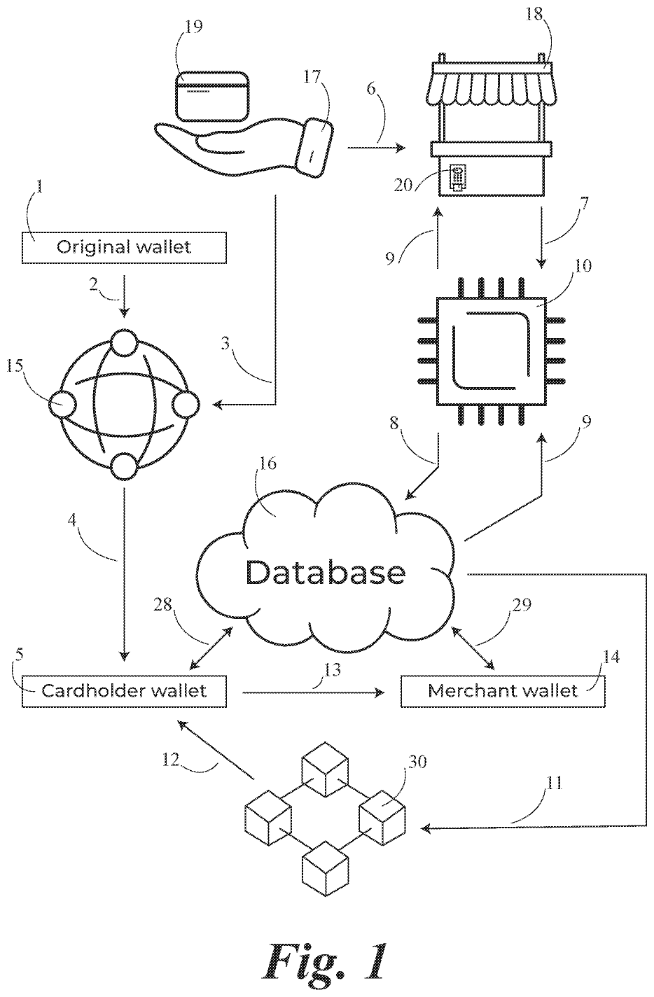

Turning now to FIG. 1, which shows a schematic view of an embodiment of the present disclosure. In this embodiment, the customer 17 begins by accessing 3 a network 15 and initiating 2 the transfer 4 of cryptocurrencies contained in the customer's original wallet 1 to the customer's cardholder wallet 5. In this embodiment, the transfer 4 is accomplished by changing the public key or address associated with the original wallet 1 to the public key or address associated with the cardholder wallet 5. Then, in this embodiment and in order to purchase goods or services, the customer 17 then proceeds by providing 6 a payment card 19 to a merchant 18. In this embodiment, the payment card 19 contains the public key or address information associated with the cardholder wallet 5. Then, in this embodiment, the customer 17 or the merchant 18 proceed by inserting the payment card 19 into the POS terminal 20. The step of inserting the payment card 19 into the POS terminal 20 initiates 7 the verification step by a processor 10 in communication with a database 16. In this embodiment, the POS terminal comprises the processor 10.

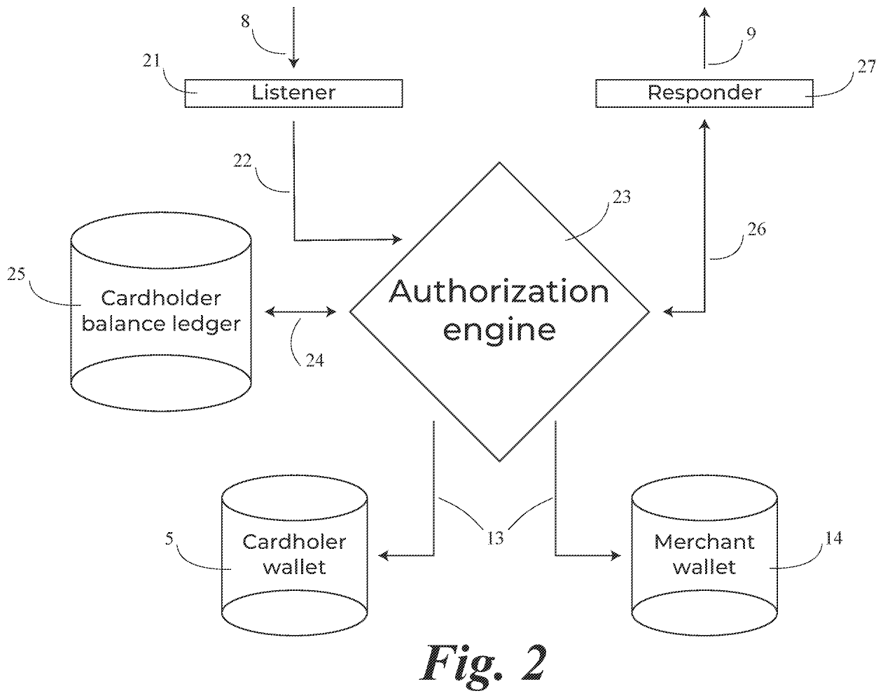

FIG. 2 shows a schematic view of an embodiment of the steps that occur within a database that receives an inbound authorization request 8; however, still referring to FIG. 1, the processor 10 sends an inbound authorization request 8 to a database 16 which sends an outbound authorization accept or decline response 9 to the processor 10, which then communicates the response 9 to the POS terminal. In this embodiment, the database 16 comprises database files (not shown) that reflect the amount of cryptocurrency within the cardholder wallet 5 and merchant wallet 14 due to communication 28 between the database 16 and the cardholder wallet 5 and communication 29 between the database 16 and the merchant wallet 14, respectively. If the outbound authorization response 9 is a decline response, the database 16 does not complete the transaction. However, if the outbound authorization response 9 is an accept response the database 16 initiates 11 the settling 12 of the transaction through the blockchain 30. During settlement 12 of the transaction, cryptocurrency, in the amount of the price of the goods or services being purchased by the customer 17, transfers 13 from the customer's cardholder wallet 5 to the merchant's wallet 14.

FIG. 2 shows a detailed schematic view of an embodiment of the steps carried out by a database that receives an inbound authorization request 8. In this embodiment, the inbound authorization request 8 is received by the listener 21, which communicates 22 with the authorization engine 23. In this embodiment, the listener 21 communicates 22 the transaction price to the authorization engine 23. The authorization engine 23 then attempts to obligate 24 the transaction price in cryptocurrency from the cardholder's balance ledger 25. The authorization engine 23 then transmits 26 an accept or decline response to the responder 27, which in turn responds with an outbound authorization accept or decline response 9. In this embodiment, the authorization engine 23 transmits 26 an accept response when the amount of cryptocurrency on the customer's balance ledger 25 is equal to or greater than the transaction price (i.e., the obligation 24 succeeded). On the other hand, the authorization engine 23 transmits 26 a decline response when the amount of cryptocurrency on the customer's balance ledger 25 is less than the transaction price of the transaction (i.e., the obligation 24 failed). In this embodiment, if the outbound authorization response 9 is an accept response, the authorization engine 23 transfers 13 cryptocurrency equal to the transaction price from the cardholder wallet 5 to the merchant wallet 14 using the blockchain 30 (shown in FIG. 1). In this embodiment, steps 8, 22, 24, 26, 9 (shown in FIG. 2), and 11 (shown in FIG. 1) are carried out in 15 seconds or less.

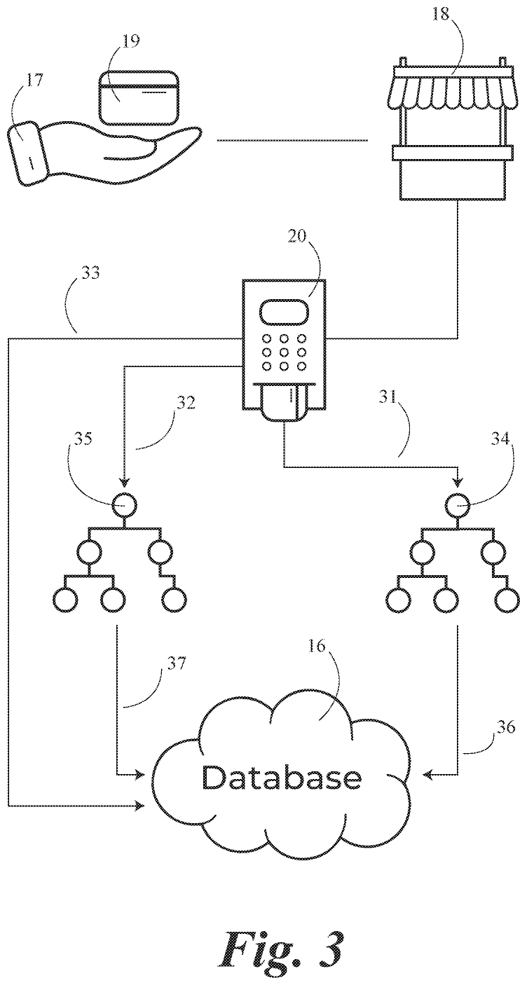

FIG. 3 shows a schematic view of three different routes the POS terminal 20 can take when authorizing and authenticating the transaction. The route taken by the POS terminal 20 may depend on the type of payment card 19 presented by the customer 17 to the merchant 18. In one embodiment, the customer 17 presents the payment card 19 to the merchant 18 by inserting the payment card 19 in the POS terminal 20. In one embodiment, the POS terminal 20 communicates 31 with a payment processor 34 that retrieves 36 information concerning the transaction from the database 16. In another embodiment, the POS terminal 20 communicates 32 with a gift card processor 35 that retrieves 37 information concerning the transaction from the database 16. In yet another embodiment, the POS terminal 20 communicates 33 directly with the database 16. In each embodiment shown, the database 16 is accessible over a network that is not a standard card transaction network.

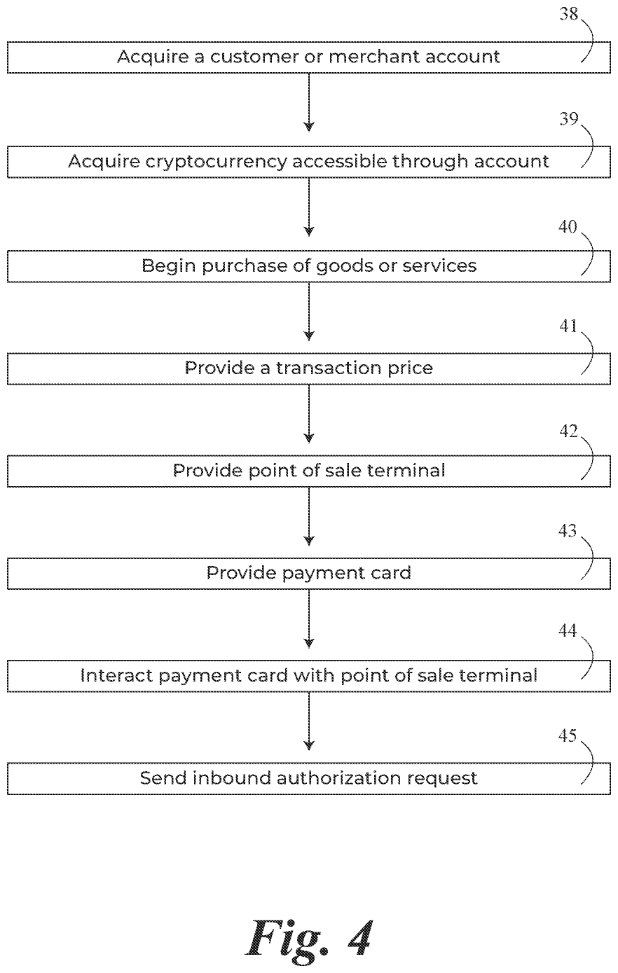

Turning now to FIG. 4, which shows a flow chart of an embodiment of the steps carried out by the customer or merchant. Here, both the customer and the merchant begin by acquiring a customer or merchant account 38. In this embodiment, at least the customer acquires cryptocurrency that is accessible through the customer's account 39. In a preferred embodiment, the cryptocurrency that is accessible through the customer's or the merchant's respective accounts is only stored in the account after a transfer of the cryptocurrency from a third-party intermediary that allows users to purchase cryptocurrency with fiat currency. Next, the customer begins the purchase of goods and/or services offered by the merchant 40. The merchant then provides a transaction price 41 for the goods and/or services and a POS terminal 42. The customer provides a payment card 43 either to the merchant or the POS terminal. In this embodiment, the payment card contains at least an address associated with the customer's account. Either the customer or the merchant interacts the payment card with the POS terminal 44. In one embodiment, either the customer or the merchant interact the payment card with the POS terminal by inserting the payment card in the POS terminal. In another embodiment, either the customer or the merchant interact the payment card with the POS terminal by swiping the payment card through the POS terminal. In yet another embodiment, either the customer or the merchant interact the payment card with the POS terminal by tapping the payment card on the POS terminal. After interacting the payment card with the POS terminal, the processor of the POS terminal sends an inbound authorization request 45 to a database.

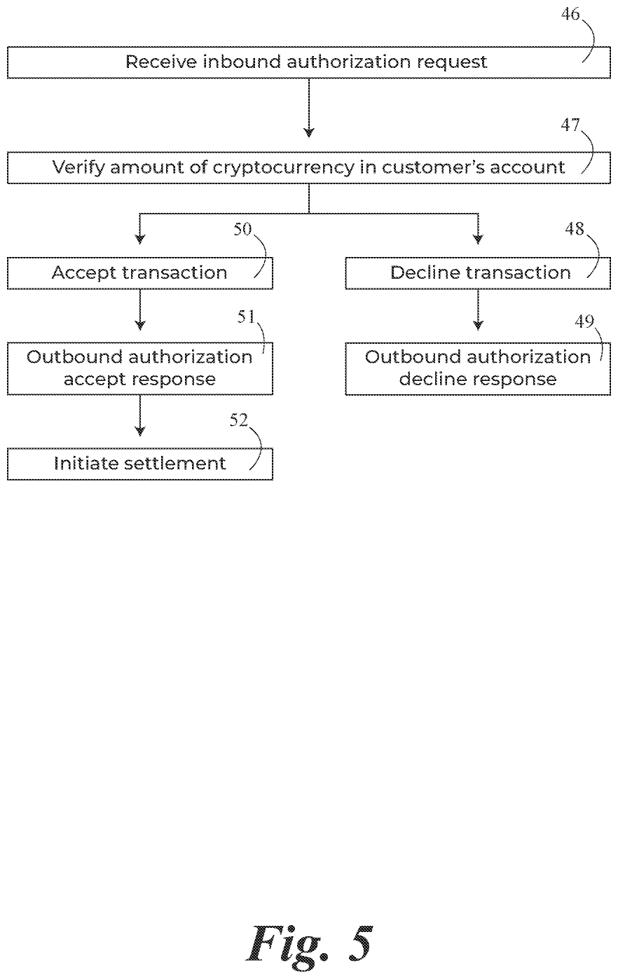

FIG. 5 shows a flow chart of an embodiment of the steps carried out by the database after the customer or the merchant interacts the payment card with the POS terminal. Here, the database is operable to receive an inbound authorization request 46 from the payment card or the POS terminal. The processor is then operable to verify the amount of cryptocurrency in the customer's account 47. If the cryptocurrency in the customer's account is less than the transaction price, the transaction will be declined 48, and the processor will accordingly transmit an outbound authorization decline response 49 to the POS terminal or the payment card. If the cryptocurrency in the customer's account is equal to or greater than the transaction price, the transaction will be accepted 50, and the processor will accordingly transmit an outbound authorization accept response 51 to the POS terminal or the payment card. In this embodiment, the processor is also operable to initiate the settlement of the transaction 52. In this embodiment, the settlement of the transaction occurs on the blockchain network.

While several variations of the present disclosure have been illustrated by way of example in preferred or particular embodiments, it is apparent that further embodiments could be developed within the spirit and scope of the present disclosure, or the inventive concept thereof. However, it is to be expressly understood that elements described in one embodiment may be incorporated with any other embodiment in combination with any other elements disclosed herein in the various embodiments. It is also to be expressly understood that any modifications and adaptations to the present disclosure are within the spirit and scope of the present disclosure, and are inclusive, but not limited to the following appended claims as set forth.

What is claimed is:

1. A cryptocurrency transaction system comprising a payment card, a point of sale terminal, a transaction price, and a database wherein the point of sale terminal comprises a processor, the processor operable to:
send an inbound authorization request to the database when the payment card interacts with the point of sale terminal;
wherein the database is operable to:
receive the inbound authorization request from the processor;
verify an amount of cryptocurrency stored within a cardholder wallet;
transmit an accept or a decline outbound authorization response from the database to the processor of the point of sale terminal;
wherein the database transmits the accept outbound authorization response to the processor of the point of sale terminal when the amount of cryptocurrency stored within the cardholder wallet is at least equal to the transaction price;
wherein the database transmits the decline outbound authorization response to the processor of the point of sale terminal when the amount of cryptocurrency stored within the cardholder wallet is less than the transaction price;
the database further operable to initiate a settlement process for the cryptocurrency transaction when the outbound authorization response is the accept outbound authorization response, wherein the settlement process for the cryptocurrency transaction comprises the step of:
transferring the amount of cryptocurrency equal to the transaction price stored within the cardholder wallet to a merchant wallet.

2. The cryptocurrency transaction system of claim 1, wherein the processor communicates with a payment processor.

3. The cryptocurrency transaction system of claim 1, wherein the database further comprises a listener port and a responder port, the database being further operable to receive the inbound authorization request through the listener port and transmit the outbound authorization response through the responder port.

4. The cryptocurrency transaction system of claim 1, wherein the database is stored on a server, and the database comprises a plurality of database files and a balance ledger, the plurality of database files comprising at least a customer's database files and a merchant's database files.

5. The cryptocurrency transaction system of claim 4, wherein the customer's database files represent the amount of cryptocurrency stored within the customer's digital wallet by a first plurality of cryptocurrency points, and the merchant's database files represent an amount of cryptocurrency stored within the merchant's digital wallet by a second plurality of cryptocurrency points.

6. The cryptocurrency transaction system of claim 5, wherein the balance ledger reveals at least the first plurality of cryptocurrency points to an authorization engine, which operates the database, and the authorization engine transfers on the server at least a portion of the first plurality of cryptocurrency points from the customer's database files to the merchant's database files when the outbound authorization response is the accept outbound authorization response, wherein the portion of the first plurality of cryptocurrency point represents the transaction price.

7. The cryptocurrency transaction system of claim 1, wherein the database is operable receive the inbound authorization request; verify the amount of cryptocurrency stored within the cardholder wallet; and transmit an accept or a decline outbound authorization response to the processor in at most approximately fifteen seconds.

8. The cryptocurrency transaction system of claim 1, wherein the database is accessible to the processor through a network.

9. The cryptocurrency transaction system of claim 8, wherein the network is not a standard card transaction network.

10. The cryptocurrency transaction system of claim 1, wherein the processor communicates with a gift card processor.

11. The cryptocurrency transaction system of claim 1, wherein the payment card is a gift card.

12. The cryptocurrency transaction system of claim 1, wherein the payment card is a credit card or a debit card.

13. A method of using cryptocurrency to facilitate a transaction comprising the steps of:
acquiring an amount of cryptocurrency, wherein the amount of cryptocurrency is stored in a cardholder wallet;
providing a transaction price, a point of sale terminal, and a database;
providing a payment card to the point of sale terminal; wherein a processor carries out the step of:
sending an inbound authorization request to the database;
wherein the database carries out the steps of:
receiving an inbound authorization request;
verifying the amount of cryptocurrency stored in the cardholder wallet;
transmitting an outbound authorization response from the database to the processor of the point of sale terminal, wherein the outbound authorization response is an accept outbound authorization response when the amount of cryptocurrency stored in the cardholder wallet is at least equal to the transaction price, and the outbound authorization response is a decline outbound authorization response when the amount of cryptocurrency stored in the cardholder wallet is less than the transaction price; and
initiating a settlement process for the transaction, the settlement process comprising the step of:
transferring the amount of cryptocurrency equal to the transaction price stored in the cardholder wallet to a merchant wallet.

14. The method of using cryptocurrency to facilitate a transaction of claim 13, wherein the payment card communicates an address associated with the cardholder wallet to the point of sale terminal when the payment card is provided to the point of sale terminal.

15. The method of using cryptocurrency to facilitate a transaction of claim 13, wherein the database verifies the amount of cryptocurrency stored in the cardholder wallet, and the database is located on a server.

16. The method of using cryptocurrency to facilitate a transaction of claim 15, wherein the database comprises a plurality of database files and a balance ledger, the plurality of database files comprising at least a customer's database files and a merchant's database files.

17. The method of using cryptocurrency to facilitate a transaction of claim 16, wherein the customer's database files represent the amount of cryptocurrency stored within the cardholder wallet by a first plurality of cryptocurrency points, and the merchant's database files represent an amount of cryptocurrency stored within the second digital wallet by a second plurality of cryptocurrency points.

18. The method of using cryptocurrency to facilitate a transaction of claim 17, wherein the balance ledger reveals at least the first plurality of cryptocurrency points to an authorization engine, which operates the database, and the authorization engine carries out the step of transferring on the server at least a portion of the first plurality of cryptocurrency points from the customer's database files to the merchant's database files when the outbound authorization response is the accept outbound authorization response, wherein the portion of the first plurality of cryptocurrency point represents the transaction price.

19. The method of using cryptocurrency to facilitate a transaction of claim 13, wherein the database carries out the steps of receiving the inbound authorization request; verifying the amount of cryptocurrency stored within the cardholder wallet; and transmitting an outbound authorization response to the processor in at most approximately fifteen seconds.

20. The method of using cryptocurrency to facilitate a transaction of claim 13, wherein the step of the settlement process and the steps carried out by the processor and the database occur on a network, wherein the network is not a standard card transaction network.
